(19) United States
(12) Patent Application Publication
(10) Pub. No.: US 2013/0039644 A1
(43) Pub. Date: Feb. 14, 2013

(54) OPTICAL NETWORK APPARATUS

(71) Applicants: Miwa TANIGUCHI, Kawasaki (JP); Yuji Shimada, Kawasaki (JP); Yoshinobu Matsukawa, Kawasaki (JP)

(72) Inventors: Miwa TANIGUCHI, Kawasaki (JP); Yuji Shimada, Kawasaki (JP); Yoshinobu Matsukawa, Kawasaki (JP)

(73) Assignee: FUJITSU LIMITED, Kawasaki-shi (JP)

(21) Appl. No.: 13/561,684

(22) Filed: Jul. 30, 2012

(30) Foreign Application Priority Data
Aug. 8, 2011 (JP) 2011-172817

(51) Int. Cl. H04B 10/08

(52) U.S. Cl. 398/10; 398/17

(57) ABSTRACT

There is provided an optical network apparatus included in an optical network in which alarm information including a type and a position of a generated failure is transferred, the optical network apparatus including: a reception unit configured to detect alarm information from a received signal, generate alarm code information representing content of an alarm from the alarm information, and transmit a signal including the alarm code information; a transfer unit configured to switch and transfer the signal transmitted from the reception unit; and a transmission unit configured to replace the alarm information included in the signal transferred from the transfer unit, based on the alarm code information, setting information of the transmission unit and setting information of the reception unit, and to transmit the signal including the replaced alarm information.

### CROSS-REFERENCE TO RELATED APPLICATION

This application is based upon and claims the benefit of priority of the prior Japanese Patent Application No. 2011-172817, filed on Aug. 8, 2011, the entire contents of which are incorporated herein by reference.

### FIELD

The embodiment discussed herein is related to an optical network apparatus which transmits optical signals.

### BACKGROUND

In recent years, capacity of an optical transmission path has been increased and capacity of an optical network apparatus has been increased in a field of optical network apparatuses, and communication capacity of 40 Gbps and furthermore communication capacity of 100 Gbps are pursued. Therefore, efficient network operation using an OTN (Optical Transport Network) has been demanded and a necessity for a cross-connect switching function in an ODU (Optical Data Unit) layer is increased. To realize provision of the cross-connect switching function, GMP (Generic Mapping Procedure) mapping for accommodating various client signals (which conform to the OC3, the OC12, the 1 GbE, the FC and the like) in the OTN is standardized and the client signals are efficiently accommodated in the OTN. Furthermore, with this, an alarm transmission/overhead process (hereinafter referred to as “signal replacement”) is standardized by the ITU-T G.798.

In a DWDM (Dense Wavelength Division Multiplexing) system in a network conforming to the OTN, various client signals are efficiently multiplexed and converted into an OTN/ODU frame of 10 G/40 G/100 G and the OTN/ODU frame is assigned to one wavelength so that capacity of the network is increased.

Meanwhile, a signal supplied to a WDM (Wavelength Division Multiplexing) System is requested to be fed back to the OTN/ODU frame. Therefore, demands for a muxponder function and a cross-connect switching function of the OTN are increased. Note that the muxponder function is a function of transmitting and receiving optical signals after multiplexing or demultiplexing the optical signal. The cross-connect switching function has a function for performing a process of switching a signal in addition to the muxponder function.

As described above, the OTN apparatus preferably realizes a signal replacement function performed for each OTN/ODU layer defined in the ITU-T G.709 and the ITU-T G.798. In this case, in an apparatus having an OTN muxponder (OTN-MXP) function or an XC (Cross-connect) function, when signal replacement of ODU-OH (Optical Data Unit-OverHead) such as tandem connection monitoring (hereinafter referred to as “TCM”) and an ODU FTFL (Fault Type and Fault Location reporting channel) is to be provided in accordance with the ITU-T G.709 and G798 standards, functional blocks illustrated in FIG. 1 are configured.

FIGS. 1 to 5 are block configurations of an optical network apparatus which conform to the ITU-T G.709 and G798 standards. FIG. 1 is a diagram illustrating an entire configuration of the optical network apparatus. Optical signals transmitted between an optical transmission path and the optical network apparatus include HO-OTU/ODU (Higher Order-Optical Transport Unit/Optical Data Unit) signals. An HO-OTU/ODU block 10 performs an overhead signal process on the optical signals and a MUX/DEMUX 11 multiplexes higher order signals and lower order signals of the optical signals and demultiplexes the optical signals so as to obtain the higher order signals and the lower order signals. LO-ODU (Lower Oder-Optical Data Unit) blocks 12 performs an overhead signal process on the lower order signals of the optical signals which have been obtained through the demultiplexing performed by the MUX/DEMUX 11.

An LO-OTU (Lower Oder-Optical Transport Unit) block 13 receives lower order signals transmitted from the optical transmission path and performs an overhead signal process and the like on the lower order signals. An optical cross-connect device (XCON BLOCK X) 14 performs a switching process on the optical signals which have been subjected to a lower-order signal process performed by the LO-OTU block 13 or the LO-ODU blocks 12. As described above, the lower order signals which have been obtained through the demultiplexing and which have been subjected to the switching process are subjected to the overhead signal process performed by the LO-OTU block 13 or the LO-ODU blocks 12 and are directly output or are multiplexed by the MUX/DEMUX 11 and thereafter subjected to a higher-order signal process performed by the HO-OTU/ODU block 10 before being outputted. Alternatively, signals output from the optical cross-connect device 14 is directly processed by a client signal block 15 and transmitted to a client apparatus.

Note that each of the blocks illustrated in FIG. 1 may be configured by a one-chip semiconductor and functions of the blocks may be realized as hardware circuits or may be realized as firmware executed by a processor.

FIG. 2 is a diagram illustrating a block configuration of each of the HO-OTU/ODU blocks 10. In FIG. 2, a Sync [RX] 20 is a portion which receives a frame of an optical signal and performs a frame synchronization process so as to perform frame recognition. An OTU_IG OH [RX] 21 is a processing unit which performs an OTU layer overhead ingress reception process (a process performed on an OH (OverHead) signal and a process performed on alarm information). An OTU_IG OH [TX(INS)] 22 is a processing unit which performs an OTU layer overhead ingress transmission process (a replacement process performed on an OH signal and alarm information). Note that an MS INSs (Maintenance Signal INSersion) 23 are processing units which insert a maintenance management signal into a frame.

An ODU_IG OH/ODUT_IG OH [RX] 24 is a processing unit which performs an ODU/TCMx layer overhead ingress reception process. An ODU_IG OH/ODUT_IG OH [TX(INS)] 25 is a processing unit which performs an ODU/TCMx layer overhead ingress transmission process (a replacement process performed on an OH signal and alarm information). An ODU_EG OH/ODUT_EG OH [RX] 26 is a processing unit which performs an ODU/TCMx layer overhead egress reception process. An ODU_EG OH/ODUT_EG OH [TX(INS)] 27 is a processing unit which performs an ODU/TCMx layer overhead egress transmission process (a replacement process performed on an OH signal and alarm information).

An OTU_EG OH [RX] 28 is a processing unit which performs an OTU layer overhead egress reception process. An OTU_EG OH [TX(INS)] 29 is a processing unit which performs an OTU layer overhead egress transmission process (a replacement process performed on an OH signal and alarm information).

FIG. 3 is a block configuration of the LO-OTU block 13. Since an internal configuration of the LO-OTU block 13 is substantially the same as that of the HO-OTU/ODU block 10 illustrated in FIG. 2, the same components are denoted by the same reference numerals and detailed descriptions thereof are omitted.

Note that the internal configuration illustrated in FIG. 3 is different from that of FIG. 2 in that a Sync [RX] 20a is provided on an egress side and the blocks process lower order signals.

FIG. 4 is a block configuration of one of the LO-ODU blocks 12. Also in FIG. 4, components the same as those illustrated in FIG. 2 are denoted by reference numerals the same as those illustrated in FIG. 2, and detailed descriptions thereof are omitted.

The configuration illustrated in FIG. 4 is the same as that of FIG. 3 in that a frame synchronization process is performed on a received signal by the Sync [RX] 20 and the Sync [RX] 20a, an overhead signal process of the ODU is performed, and a maintenance management signal is inserted, but is different from that of FIG. 3 in that blocks of an OTU level are not provided.

FIG. 5 is a block diagram illustrating the client signal block 15. Also in FIG. 5, components the same as those illustrated in FIG. 2 are denoted by reference numerals the same as those illustrated in FIG. 2, and detailed descriptions thereof are omitted.

In FIG. 5, the client signal block 15 includes a client signal OH [RX] 30 and a client signal OH [TX(INS)] 31 which process an overhead signal of a client signal so as to transmit a signal to a client apparatus and receive a signal from the client apparatus. Furthermore, the client signal block 15 includes a client signal MS INS 32 used to insert a maintenance management signal for a client signal.

FIGS. 6A and 6B are diagrams illustrating TCMx OH(x=1 to 6)/FTFL OH in an OTN frame. In FIG. 6A, “FAS” represents a “frame alignment signal”, “MFAS” represents a “multiframe alignment signal”, “SM” represents “section monitoring”, “GCC” represents a “general communication channel”, “RES” represents “reserved for future international standardization”, “PM” represents “path monitoring”, “TCM” represents “tandem connection monitoring”, “PM&TCM” represents “path monitoring & tandem connection monitoring”, “ACT” represents an “activation/deactivation control channel”, “FTFL” represents a “fault type & fault location reporting channel”, “EXP” represents “experimental”, “APS” represents a “automatic protection switching coordination channel”, and “PCC” represents a “protection communication control channel”.

Note that, in the TCM, segmentation is freely performed regions other than a termination block. Furthermore, the FTFL allows addition of information on a position where a failure occurs to alarm information and transmission of the information.

As illustrated in FIG. 6B, the FTFL may be divided into a forward portion (FW FTFL) including 0th to 127th bytes and a backward portion (BW FTFL) including 128th to 255th bytes. Each of the portions includes a fault indication field, an operator identifier field, and an operator specific field.

FIGS. 7 and 8 are diagrams illustrating configurations of an apparatus in a case where the configuration in the related art is implemented in an OTN-SW (Optical Transport Network Switch) apparatus of 100 G. In FIGS. 7 and 8, components the same as those illustrated in FIGS. 1 and 4 are denoted by reference numerals the same as those illustrated in FIGS. 1 and 4, and detailed descriptions thereof are omitted.

When the functional blocks in the configuration of the apparatus in the related art illustrated in FIGS. 1 to 5 are implemented in the OTN-SW apparatus of 100 G, the functional blocks of ingress and egress (including the HO-OTU/ODU block 10, the LO-ODU blocks 12 and the LO-OTU block 13) on a network side corresponding to 100 G, that is, 80 ODU0 blocks at maximum, one ODU4 block, and one OTU4 block are preferably provided. On the other hand, the number of client blocks depends on capacitive reactance XC of the apparatus and the system. Furthermore, the number of blocks to be connected is increased depending on a type of a client signal and the number of functional blocks is considerably increased as the capacitive reactance XC is increased. This is true for a case where an HO interface of an OTN-MXP which is the OTN-SW corresponds to 2.5 G (OTU1), 10 G (OTU2), and 40 G (OTU3).

As described above, 80 LO-ODUk blocks are preferably used at maximum, and each of the LO-ODUk blocks preferably includes functional blocks of the four MS INSs 23, the Sync [RX] 20, the Sync [RX] 20a, the ODU_IG OH/ODUT_IG OH [RX] 24, the ODU_IG OH/ODUT_IG OH [TX(INS)] 25, the ODU_EG OH/ODUT_EG OH [RX] 26, and the ODU_EG OH/ODUT_EG OH [TX(INS)] 27 as illustrated in FIG. 8. Accordingly, it is apparent that, if 80 LO-ODUk blocks are to be provided, a large number of functional blocks are provided.

If an apparatus including such a large number of functional blocks mounted thereon is designed, capacity of components is increased, the number of components is increased, and therefore, power consumption is increased and cost is increased. Accordingly, it is difficult to design such an apparatus in terms of implementation, power consumption, and cost.

In the related art disclosed in Japanese Laid-open Patent Publication No. 2007-318603, a system configuration in which different line interfaces are connected to each other through cross-connect includes an alarm information transmission unit and an alarm is transmitted through the alarm information transmission unit.

### SUMMARY

According to an aspect of the embodiment, there is provided an optical network apparatus included in an optical network in which alarm information including a type and a position of a generated failure is transferred, the optical network apparatus including: a reception unit configured to detect alarm information from a received signal, generate alarm code information representing content of an alarm from the alarm information, and transmit a signal including the alarm code information; a transfer unit configured to switch and transfer the signal transmitted from the reception unit; and a transmission unit configured to replace the alarm information included in the signal transferred from the transfer unit, based on the alarm code information, setting information of the transmission unit and setting information of the reception unit, and to transmit the signal including the replaced alarm information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a block configuration of an optical network apparatus which conforms to the standard of ITU-T G.709 and G798 (part 1);

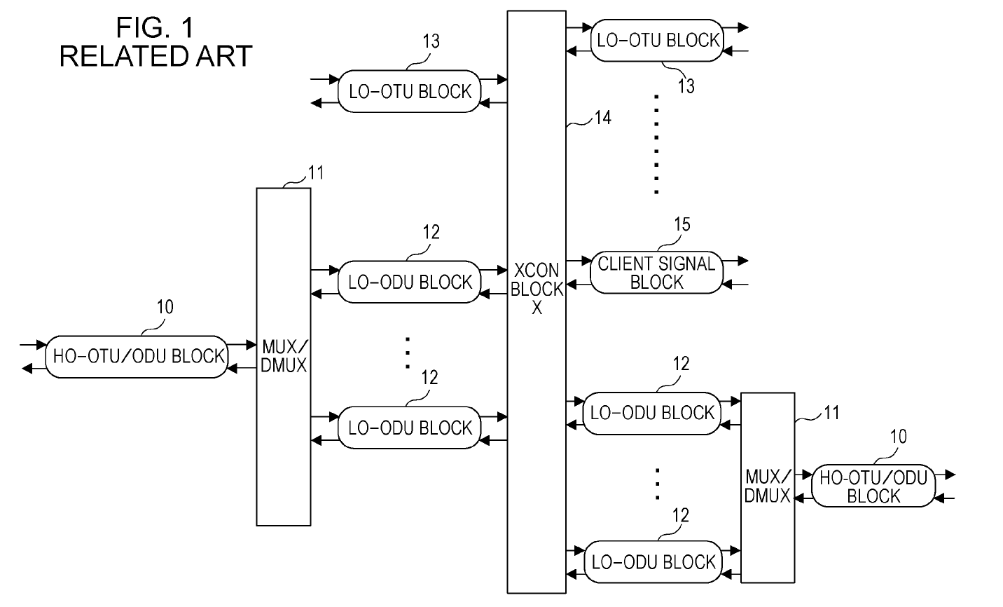

FIG. 2 is a diagram illustrating a block configuration of the optical network apparatus which conforms to the standard of ITU-T G.709 and G798 (part 2);

FIG. 3 is a diagram illustrating a block configuration of the optical network apparatus which conforms to the standard of ITU-T G.709 and G798 (part 3);

FIG. 4 is a diagram illustrating a block configuration of the optical network apparatus which conforms to the standard of ITU-T G.709 and G798 (part 4);

FIG. 5 is a diagram illustrating a block configuration of the optical network apparatus which conforms to the standard of ITU-T G.709 and G798 (part 5);

FIGS. 6A and 6B are diagrams illustrating TCMx OH (x=1 to 6)/FTFL OH in an OTN frame;

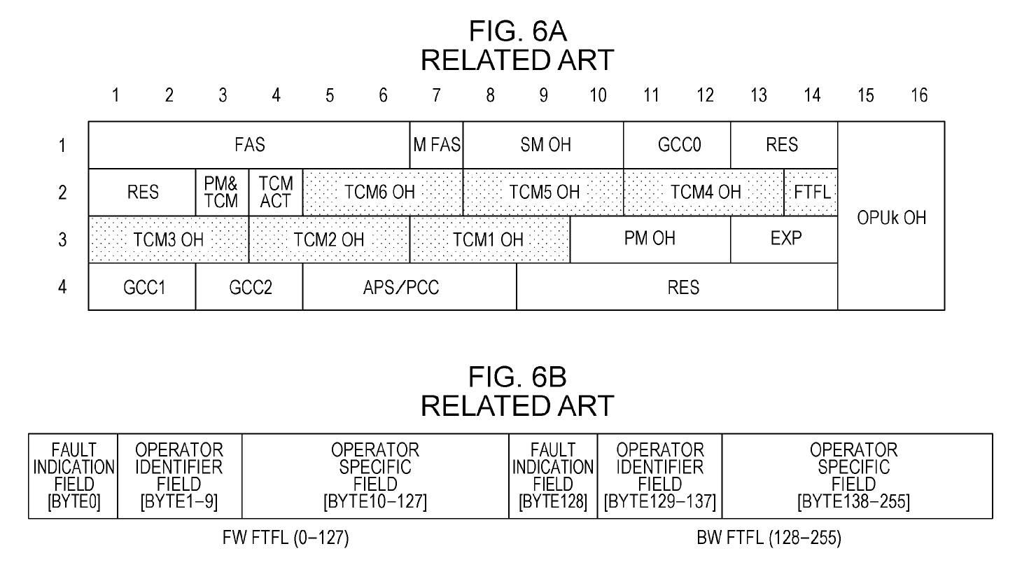

FIG. 7 is a diagram illustrating a configuration of an OTN-SW (Optical Transport Network Switch) apparatus of 100 G in a case where the configuration in the related art is implemented in the apparatus (part 1);

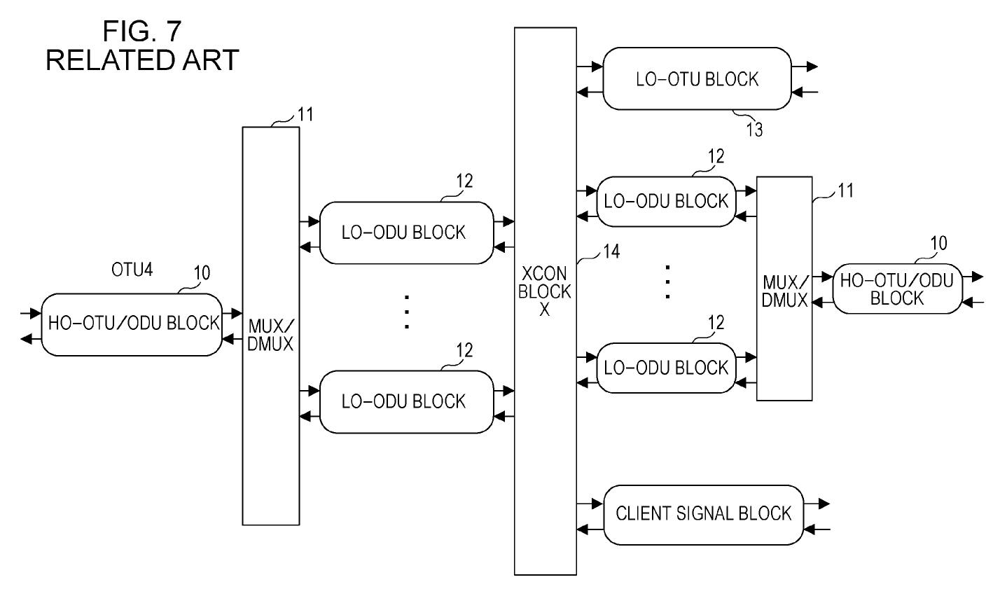

FIG. 8 is a diagram illustrating a configuration of the OTN-SW apparatus of 100 G in a case where the configuration in the related art is implemented in the apparatus (part 2);

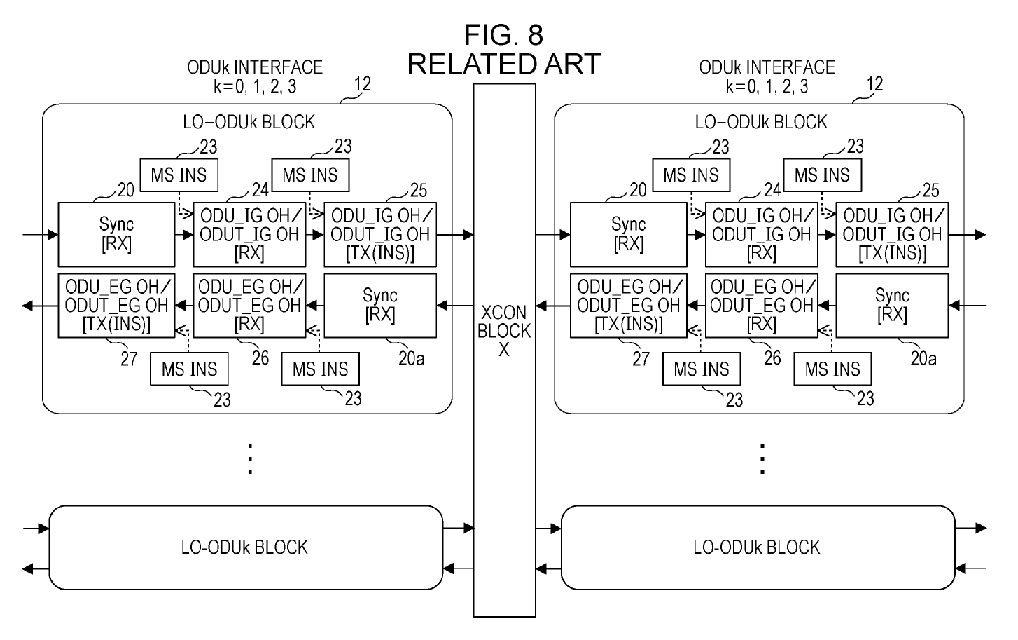

FIG. 9 is a diagram illustrating functional blocks of an XC apparatus according to an embodiment;

FIG. 10 is a diagram illustrating functional blocks of the XC apparatus and operations of the functional blocks (part 1);

FIG. 11 is a diagram illustrating the functional blocks of the XC apparatus and the operations of the functional blocks (part 2);

FIG. 12 is a diagram illustrating an ALM CODE transmission unit (part 1);

FIG. 13 is a diagram illustrating the ALM CODE transmission unit (part 2);

FIG. 14 is a diagram illustrating a method for transmitting alarm code information (part 1);

FIG. 15 is a diagram illustrating the method for transmitting the alarm code information (part 2);

FIG. 16 is a diagram illustrating the method for transmitting the alarm code information (part 3);

FIG. 17 is a diagram illustrating a determination and a process performed by a control information processing block having a TCM OH value when signal replacement is performed to obtain an ODUk-AIS (part 1);

FIG. 18 is a diagram illustrating a determination and a process performed by the control information processing block having the TCM OH value when the signal replacement is performed to obtain the ODUk-AIS (part 2);

FIG. 19 is a diagram illustrating a determination and a process performed by the control information processing block having an insertion value of FTFL-OH (part 1);

FIG. 20 is a diagram illustrating a determination and a process performed by the control information processing block having the insertion value of FTFL-OH (part 2);

FIGS. 21A and 21B are diagrams illustrating a determination and a process performed by the control information processing block when signal replacement is performed to obtain ODUk-OCI (part 1);

FIG. 22 is a diagram illustrating a determination and a process performed by the control information processing block when the signal replacement is performed to obtain the ODUk-OCI (part 2);

FIGS. 23A and 23B are diagrams illustrating a determination and a process performed by the control information processing block when signal replacement is performed to obtain ODUk-LCK (part 1);

FIG. 24 is a diagram illustrating a determination and a process performed by the control information processing block when the signal replacement is performed to obtain the ODUk-LCK (part 2);

FIG. 25 is a diagram illustrating an image of a network which conforms to OTN to which the embodiment is to be applied;

FIG. 26 is a diagram illustrating a configuration of an ODU cross-connect apparatus;

FIG. 27 is a diagram illustrating a block configuration of the ODU cross-connect apparatus to which the embodiment is applied (part 1);

FIG. 28 is a diagram illustrating a block configuration of the ODU cross-connect apparatus to which the embodiment is applied (part 2);

FIG. 29 is a diagram illustrating a block configuration of an ODU repeater apparatus (part 1);

FIG. 30 is a diagram illustrating a block configuration of the ODU repeater apparatus (part 2);

FIG. 31 is a diagram illustrating a block configuration of an ODU Muxponder apparatus;

FIG. 32 is a diagram illustrating a signal replacement process performed in accordance with a type of a client signal in a client signal block process on an egress side; and

FIG. 33 is a diagram illustrating a process of stopping an output of an optical module performed irrespective of a type of a client signal in the client signal block process on the egress side.

### DESCRIPTION OF EMBODIMENT

In this embodiment, a configuration of functional blocks in implementation of a signal replacement function associated with an ODU overhead (OH) (hereinafter referred to as “ODU-OH”) which is standardized by the ITU-T G.709 and the ITU-T G 798 in an apparatus (OTN-SW) having OTN muxponder (OTN-MXP) and a cross-connect (XC) switching function of the OTN will be described. Specifically, in this embodiment, overlapped functional blocks are removed.

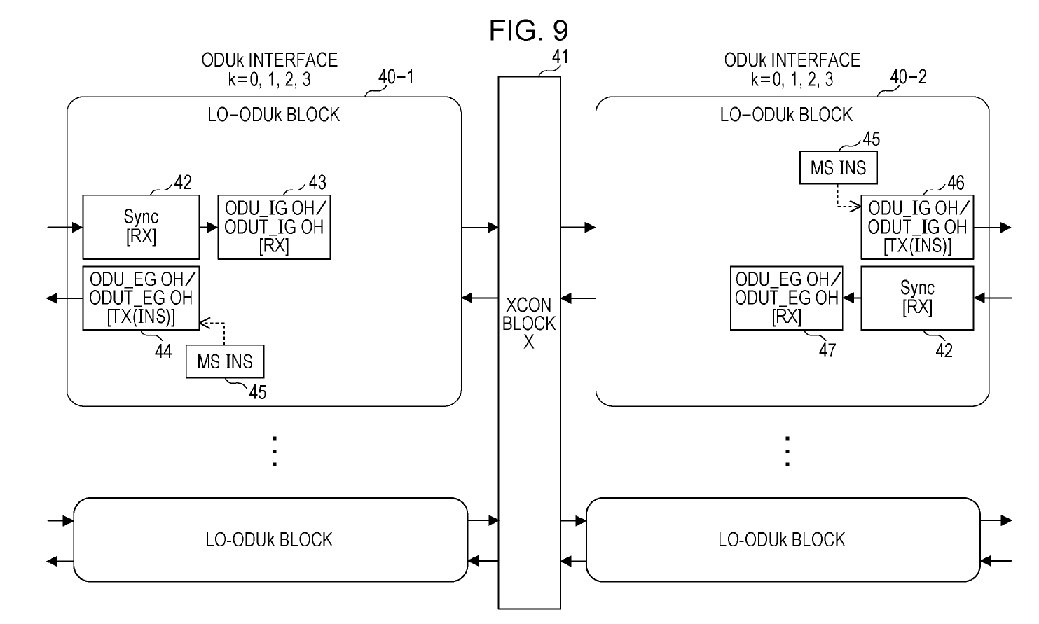

FIG. 9 is a diagram illustrating functional blocks of an XC apparatus of this embodiment. As illustrated in FIG. 9, the XC apparatus includes LO-ODUk blocks 40 on ingress and egress sides and signals supplied through the LO-ODUk blocks 40 are subjected to a switching process by an XC processor (XCON block X) 41. Note that, among functional blocks included in each of the LO-ODUk blocks 40, blocks other than a Sync [RX] 42, an ODU_IG OH/ODUT_IG OH [RX] 43, an ODU_EG OH/ODUT_EG OH [TX(INS)] 44, and an MS INS 45 are removed from an LO-ODUk block 40-1. Furthermore, blocks other than an ODU_IG OH/ODUT_IG OH [TX(INS)] 46, the Sync [RX] 42, an ODU_EG OH/ODUT_EG OH [RX] 47, and the MS INS 45 are removed from an LO-ODUk block 40-2. Then, as described below, blocks which compensate for functions of the removed blocks are added. Although the blocks are newly added, the total number of blocks is reduced as described hereinafter.

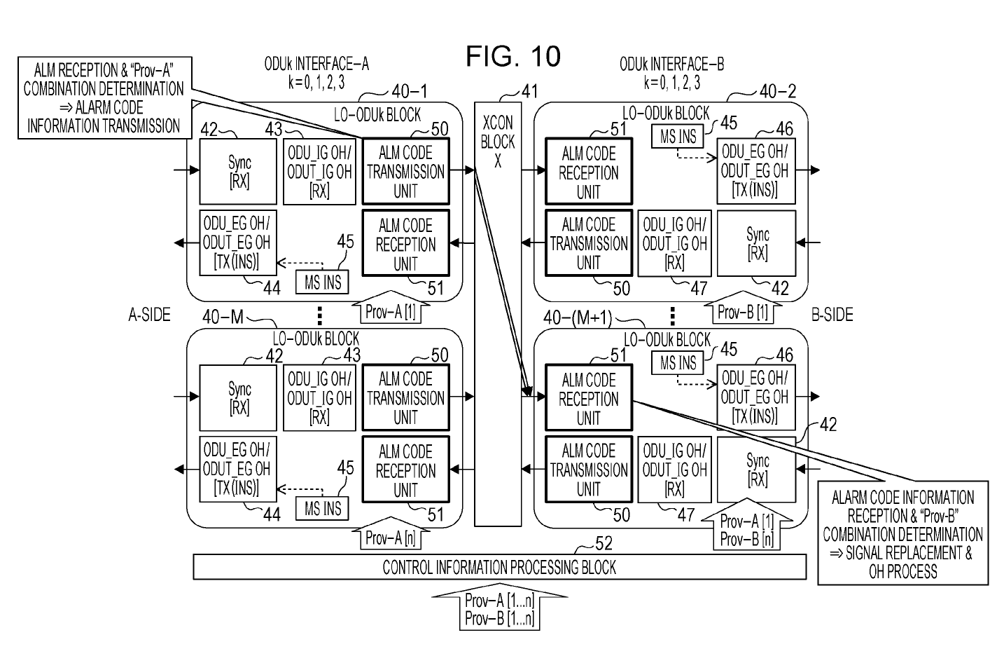

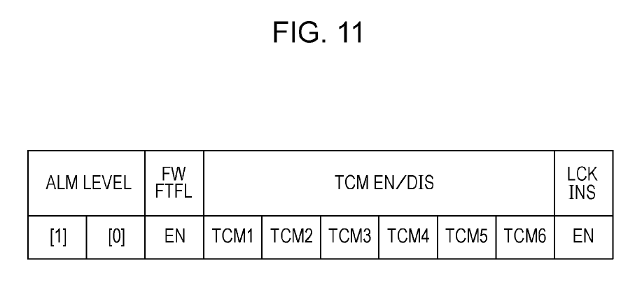

FIGS. 10 and 11 are diagrams illustrating functional blocks of the XC apparatus of this embodiment and operations of the functional blocks. As illustrated in FIG. 10, in this embodiment, overlapped RX blocks are provided only on the ingress side (ODU_EG OH/ODUT_EG OH [RX] 26 and OTU_EG OH [RX] 28 are removed) whereas overlapped TX blocks are provided only on the egress side (OTU_IG OH [TX(INS)] 22 and ODU_IG OH/ODUT_IG OH [TX(INS)] 25 are removed) so that the TX blocks on the ingress side and the RX blocks on the egress side are removed.

When the TX blocks on the ingress side are removed, signal replacement to be performed in a control state of the ingress side is not performed in accordance with alarm information transmitted to the ingress side using an alarm detected on the ingress side as a trigger. Furthermore, when the RX blocks on the egress side are removed, an alarm is not detected on the egress side. To address these problems, as illustrated in FIG. 10, an ALM code transmission unit 50, an ALM code reception unit 51, and a control information processing block 52 are provided.

The ALM code transmission unit 50 defines alarm code information as information on transmission to the egress side of a destination of the XC connection and performs a process on the alarm code information and a transmission process.

Here, the alarm code information is illustrated in FIG. 11. The alarm code information includes the following information. (1) Alarm Level Max value: A value of a detected maximum alarm level of an alarm is transmitted as an alarm level. Note that the alarm level max value is information of two bites. (2) FW FTFL EN/DIS: Information representing whether information of forward (FW) FTFL to be inserted on the ingress side is to be transmitted to the egress side of the destination of the XC connection. (3) TCM1 EN/DIS: Information representing whether a tandem connection monitoring value set on the ingress side is to be transmitted to the egress side of the destination of the XC connection. (4) TCM2 EN/DIS: Information representing whether a tandem connection monitoring value set on the ingress side is to be transmitted to the egress side of the destination of the XC connection. (5) TCM3 EN/DIS: Information representing whether a tandem connection monitoring value set on the ingress side is to be transmitted to the egress side of the destination of the XC connection. (6) TCM4 EN/DIS: Information representing whether a tandem connection monitoring value set on the ingress side is to be transmitted to the egress side of the destination of the XC connection. (7) TCM5 EN/DIS: Information representing whether a tandem connection monitoring value set on the ingress side is to be transmitted to the egress side of the destination of the XC connection. (8) TCM6 EN/DIS: Information representing whether a tandem connection monitoring value set on the ingress side is to be transmitted to the egress side of the destination of the XC connection. (9) LCK flag: Information representing whether information to which ODUk-LCK is to be inserted on the ingress side is to be transmitted to the egress side of the destination of the XC connection.

Note that the information TCM1 EN/DIS to the information TCM6 EN/DIS have meanings in accordance with the standard of the ITU-T and independently have EN/DIS values. Furthermore, the information (3) to the information (9) may be transmitted from the control information processing block 52 to the egress side and set on the egress side. In this case, the alarm code information does not include the information (3) to the information (9).

The control information processing block 52 integrates control process information and cross-connect information on the ingress side and controls the egress side.

The ALM code reception unit 51 performs the signal replacement and an OH operation determination in accordance with the alarm code information of the ALM code transmission unit 50 above and the control process information on the ingress side of the control information processing block 52 above and the control process information on the egress side.

Note that, since the XC processor (XCON block X) 41 allows bidirectional transmission of signals in FIG. 10, one side relative to the XC processor 41 is defined as an A side and the other side relative to the XC processor 41 is defined as a B side for convenience sake as illustrated in FIG. 10. “Prov-A” represents setting information used in the blocks on the A side and “Prov-B” is setting information used in the blocks on the B side. Furthermore, the Sync [RX] 42, the ODU_IG OH/ODUT_IG OH [RX] 43, and the ALM code transmission unit 50 serve as a reception unit, and the ALM code reception unit 51, the ODU_EG OH/ODUT_EG OH [TX(INS)] 44, and the MS INS 45 serve as a transmission unit. And the XC processor 41 serves as a transfer unit.

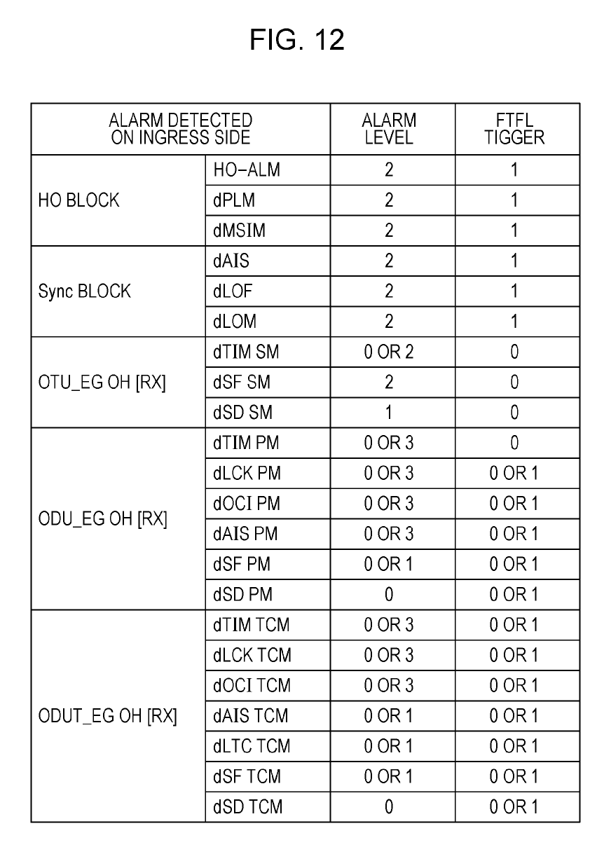

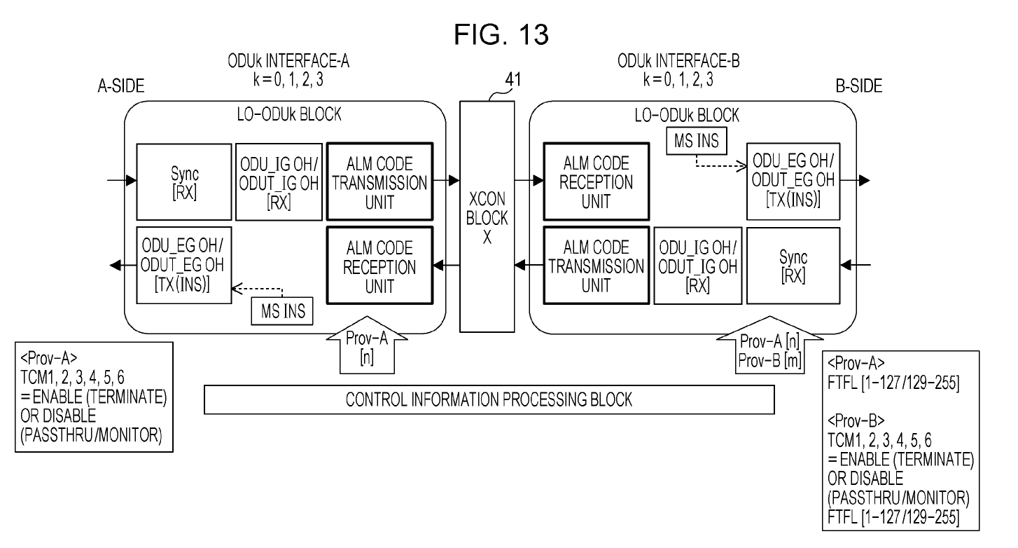

FIGS. 12 and 13 are diagrams illustrating the ALM CODE transmission unit 50. Hereinafter, a process of the ALM code transmission unit 50 described in the item 1 above will be described in detail. The ALM code transmission unit 50 defines alarm levels of alarms detected on the ingress side. In FIG. 12, the alarm levels and FTFL triggers are illustrated.

As illustrated in FIG. 12, alarms detected on the ingress side include three alarms detected by an HO block, three alarms detected by a sync block, three alarms detected by OTU_EG OH [RX], and six alarms detected by ODU_EG OH [RX], and seven alarms detected by ODUT_EG OH [RX]. Settings of alarm levels and FTFL triggers of the alarms are illustrated in FIG. 12.

The ALM code transmission unit 50 compares the alarm levels of the alarm detected by the RX blocks on the ingress side with one another, sets the highest (strongest) alarm level from among the alarm levels of the generated alarms to the alarm code information, and transmits the alarm code information to the egress side of a connection destination of the XC processor 41. Furthermore, the ALM code transmission unit 50 sets “Enable” to the FW FTFL EN/DIS of the alarm code information of detected alarms to which the FTFL triggers have been set.

When the signal replacement is not to be performed, a value smaller than a threshold value on the egress side is set to the alarm level. For example, when a threshold value for a determination as to whether the signal replacement is to be performed is 2 and the signal replacement is performed when a value is 2 or more, the alarm level is set to 0 or 1. When an overhead signal process is not to be performed on the ingress side, the alarm level is 0. When the FW FTFL is not to be inserted, the FTFL trigger represents 0.

As illustrated in FIG. 13, on the A side, the setting information Prov-A is used to set the TCM 1 to 6 to “Enable” (“Terminate”) or “Disable” (“PassThru/Monitor”). On the B side, the setting information Prov-A is used to set the FTFL and the setting information Prov-B is used to set the TCM 1 to 6 to “Enable” (“Terminate”) or “Disable” (“PassThru/Monitor”) and used to set the FTFL with the setting information Prov-A.

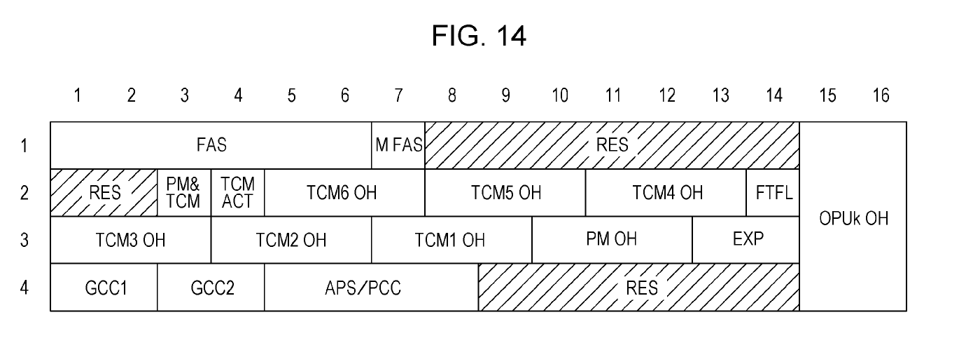

FIGS. 14 to 16 are diagrams illustrating methods for transmitting the alarm code information. The alarm code information may be transmitted to the egress side by one of the following methods. In a first method, as represented by hatching in FIG. 14, the alarm code information is mapped on reserved regions (RES) of an OH of an ODU frame which is to be subjected to the cross-connect connection.

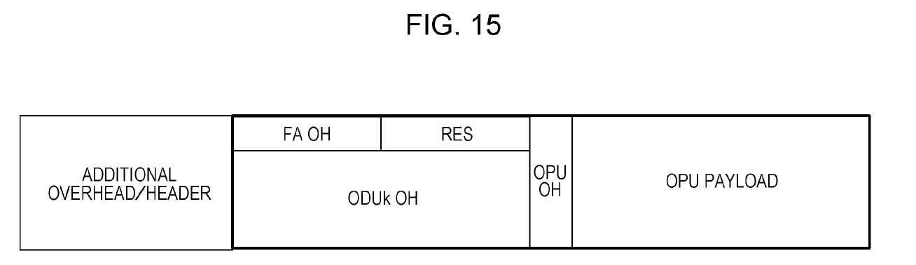

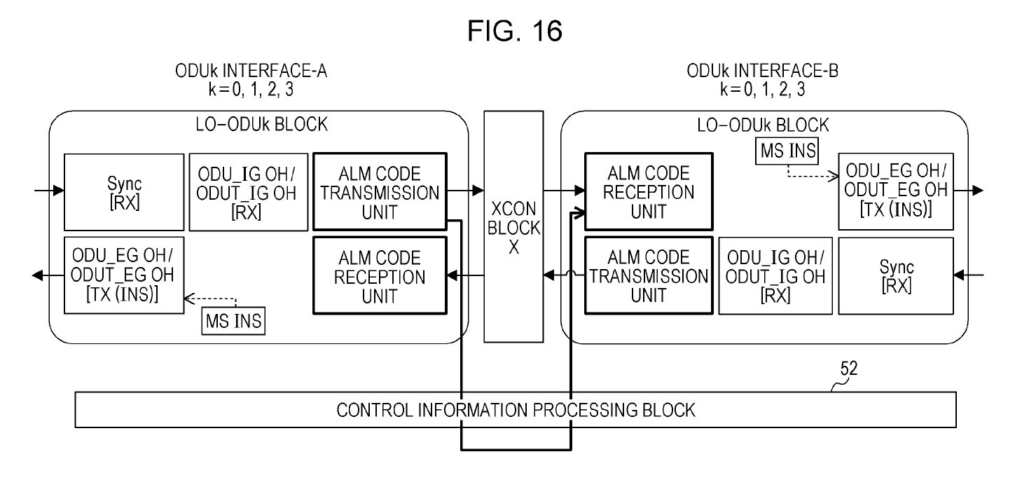

In a second method, a unique overhead/header is added to the ODU frame as illustrated in FIG. 15, and the alarm code information is mapped on the overhead/header. In a third method, the alarm code information is transmitted to a block on the egress side of the destination of the cross-connect connection through the control information processing block 52 as illustrated in FIG. 16. In these methods, the alarm detected on the ingress side is transmitted to the egress side using the alarm code information.

Hereinafter, a process of the control information processing block 52 described in the control information processing block 52 above will be described in detail. A function of the control information processing block 52 is to collectively transmit the control information and the cross-connect information (a determination as to whether the cross-connect is performed) on the ingress side to the egress side as a state of the ingress side. The control information includes an FTFL-operator ID, FTFL operator specific information, cross-connect connection information (information on the relationships between the blocks and frames to be output to the blocks), Enable/Disable information of TCMx (hereinafter “TCMx” collectively represents TCM1 to TCM6) (only when the Enable/Disable information is not included in the alarm code information), and LCK INS (only when the LCK INS is not included in the alarm code information). By transmitting the information described above to the egress side so that the information is used for control, a control state of the ingress side is recognized by the egress side.

Hereinafter, the ALM code reception unit 51 described in the item 3 above will be described. The ALM code reception unit 51 determines an ODUk OH to be output from the egress side in accordance with the alarm code information supplied from the ALM code transmission unit 50, the information on the XC processor on the ingress side supplied from the control information processing block 52, that is, the FTFL-operator ID, the FTFL operator specific information, the cross-connect connection information, the Enable/Disable information of the TCMx (only when the Enable/Disable information is not included in the alarm code information), and the LCK INS (only when the LCK INS is not included in the alarm code information), and control information on the egress side including Enable/Disable information on the TCMx, an FTF-operator ID, and FTFL operator specific information.

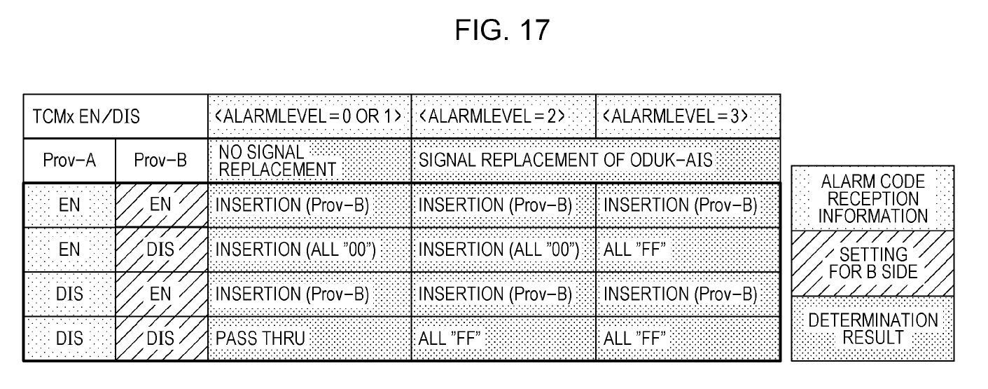

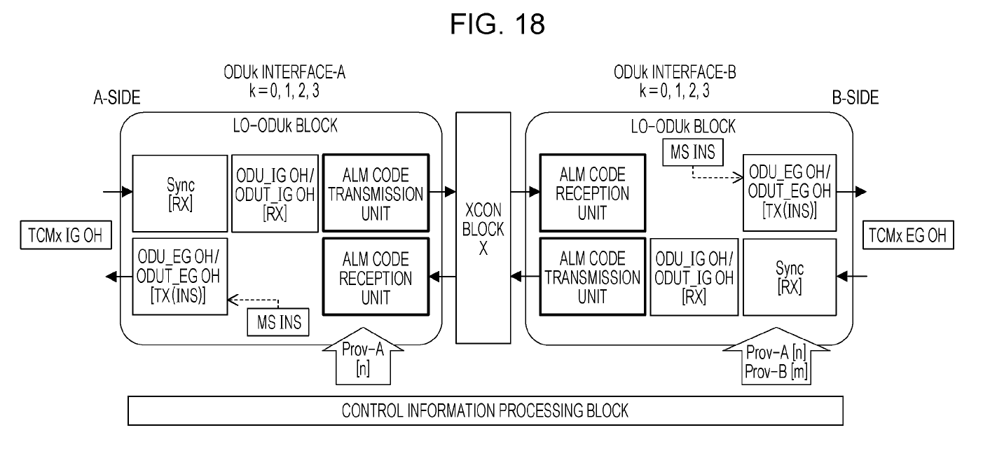

FIGS. 17 and 18 are diagrams illustrating a determination and a process performed by the control information processing block 52 having a TCM OH value when signal replacement is performed to obtain ODUk-AIS (alarm indication signal). Hereinafter, determinations of the processors in the signal replacement and control of outputting of an OH will be described in detail with reference to the drawings.

FIG. 17 illustrates a table used to determine a process to be performed. In the table of FIG. 17, the TCM has six setting values, and a result of a logical sum of the six setting values of the TCM are represented by “EN (Enable)/DIS (Disable)” of the TCMx. Therefore, if at least one of the six TCMs corresponds to “EN”, the TCMx is determined to be “EN”. Four combinations are obtained from “Enable (EN)” and “Disable (DIS)” of the setting information Prov-A and “Enable (EN)” and “Disable (DIS)” of the setting information Prov-B. In these cases, a process performed in a case where the alarm level of the alarm code information is 0 or 1, a process performed in a case where the alarm level of the alarm code information is 2, and a process performed in a case where the alarm level of the alarm code information is 3 are different from one another.

When the alarm level is 0 or 1, the signal replacement is not performed on an ODUk-AIS. When the alarm level is 2 or 3, the signal replacement is performed on the ODUk-AIS. When the setting information Prov-A corresponds to “EN” and the setting information Prov-B corresponds to “EN”, the setting information Prov-B (setting value on the B side) is inserted into the ODUk-AIS irrespective of the alarm level. Similarly, when the setting information Prov-A corresponds to “DIS” and the setting information Prov-B corresponds to “EN”, the setting information Prov-B is inserted into the ODUk-AIS irrespective of the alarm level. In a case where the setting information Prov-A corresponds to “EN” and the setting information Prov-B corresponds to “DIS”, replacement is performed such that when the alarm level is 0, 1, or 2, 0 is inserted into all the ODUk-AISs whereas when the alarm level is 3, “FF” is inserted into all the ODUk-AIS. In a case where the setting information Prov-A corresponds to “DIS” and the setting information Prov-B also corresponds to “DIS”, replacement is performed such that when the alarm level is 0 or 1, the ODUk-AIS directly passes through (Pass Thru) and otherwise, “FF” is inserted into all the ODUk-AISs. Note that, the setting information Prov-A and the setting information Prov-B represent a setting on the A side and a setting on the B side, respectively.

As illustrated in FIG. 18, the above information is transmitted from the ALM code transmission unit 50 on the A side to the ALM code reception unit 51 of a target LO-ODUk block. Information transmitted from the control information processing block 52 includes cross-connect connection information which specifies an LO-ODUk block on the B side of an output destination of a signal transmitted from a certain LO-ODUk block on the A side after the signal is subjected to a switching process performed by the XC processor (XCON BLOCK) 41. The control information processing block 52 performs a determination in accordance with the table illustrated in FIG. 17 using the alarm code information and other information supplied from the A side, generates an ODUk-AIS in the ODU_EG OH/ODUT_EG OH [TX(INS)] included in the LO-ODUk block on the B side, and outputs the signal.

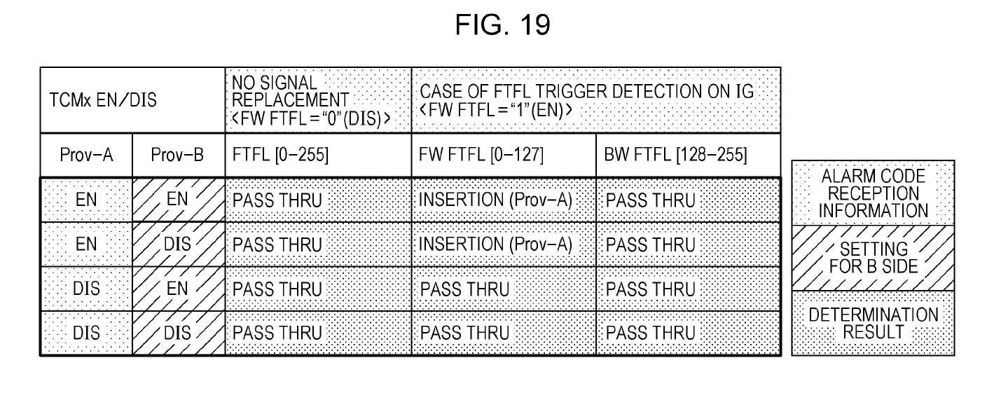

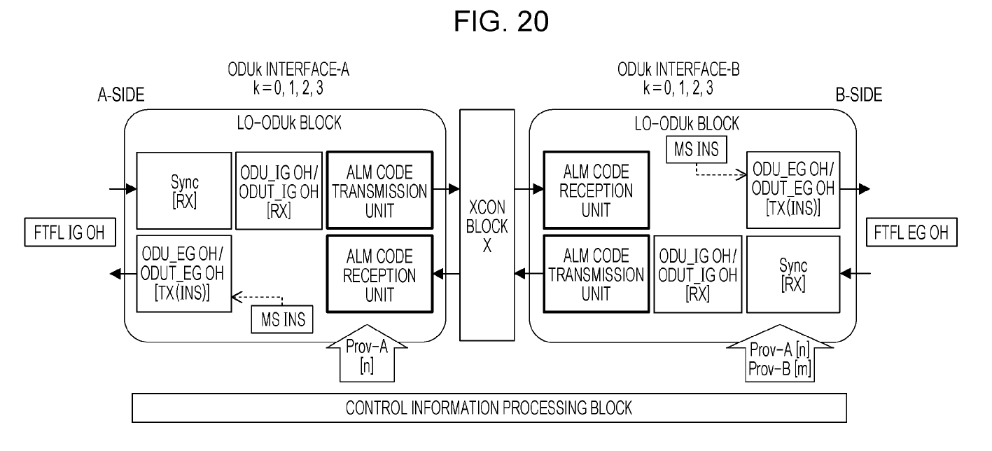

FIGS. 19 and 20 are diagrams illustrating a determination and a process performed by the control information processing block 52 having an insertion value of FTFL-OH. FIG. 19 illustrates a table used to determine a process to be performed. In the table of FIG. 19, the TCM has six setting values, and a result of a logical sum of the six setting values of the TCM is represented by “EN (Enable)/DIS (Disable)” of the TCMx. Therefore, if at least one of the six TCMs corresponds to “EN”, the TCMx is determined to be “EN”. Similarly, a result of a logical sum of all bits is represented by “EN (Enable)/DIS (Disable)” of the FW FTFL. Four combinations are obtained from “Enable (EN)” and “Disable (DIS)” of the setting information Prov-A and “Enable (EN)” and “Disable (DIS)” of the setting information Prov-B. In each of the cases, the FW FTFL transmitted as the alarm code information is 0 (DIS) or 1 (EN). When the alarm code information corresponds to “EN”, a process performed on the 0th to 127th bits (FW FTFL) in the FTFL and a process performed on the 128th to 255th bits (BW FTFL) are separately performed. When the FW FTFL corresponds to 0, the entire FTFL-OH is passed through (PassThru) irrespective of a combination of the setting information Prov-A and the setting information Prov-B of the TCMx. Furthermore, also when the FW FTFL is 1, the 128th to 255th bits (BW FTFL) of the FTFL are directly passed through. In a case where the FW FTFL is 1, the setting information Prov-A is inserted into the 0th to 127th bits (FW FTFL) of the FTFL when the setting information Pro-A of the TCMx corresponds to “EN”, and otherwise, the FW FTFL is directly passed through (PassThru). Note that, the setting information Prov-A and the setting information Prov-B represent a setting on the A side and a setting on the B side, respectively.

As illustrated in FIG. 20, the alarm code information and other information are transmitted from the ALM code transmission unit 50 on the A side to the ALM code reception unit 51 on the B side, and the information is used to generate an FTFL EG OH in the ODU_EG OH/ODUT_EG OH [TX(INS)].

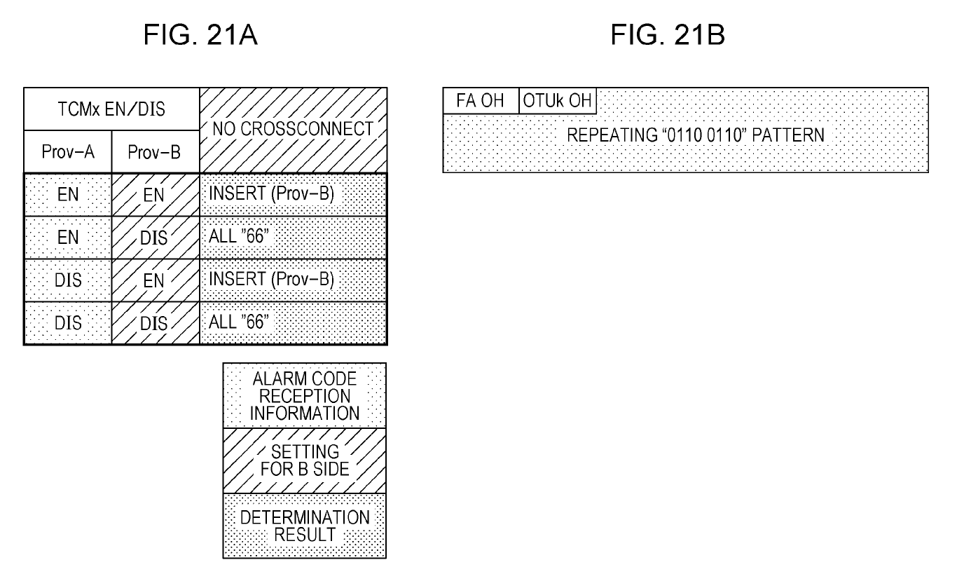

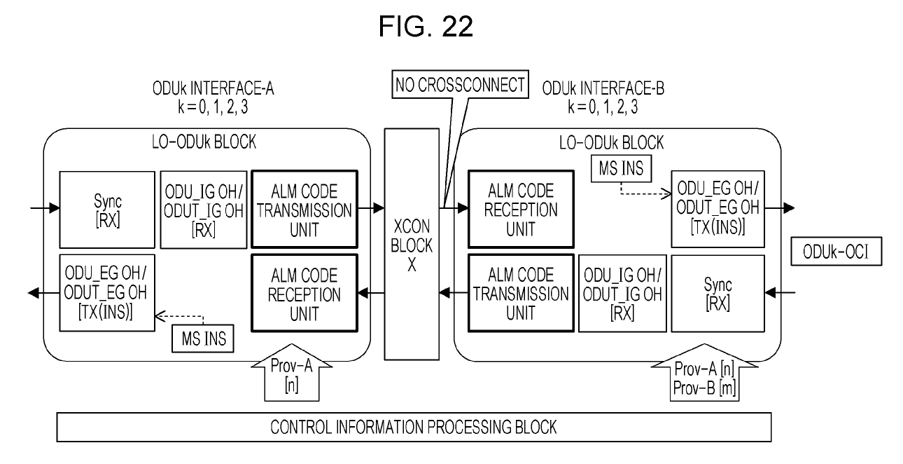

FIGS. 21A, 21B, and 22 are diagrams illustrating a determination and a process performed by the control information processing block 52 when signal replacement is performed to obtain ODUk-OCI. The ODUk-OCI is information representing whether the XC processor 41 performs a switching process in the optical network apparatus. Only when a cross-connect process is not performed, the signal replacement is performed. In a table illustrated in FIG. 21A, the TCM has six setting values, and a result of a logical sum of the six setting values of the TCM is represented by “EN (Enable)/DIS (Disable)” of the TCMx. Therefore, if at least one of the six TCMs corresponds to “EN”, the TCMx is determined to be “EN”. As illustrated in FIG. 21A, when the setting information Prov-B represents “EN”, the setting information Prov-B is inserted into the ODUk-OCI irrespective of the setting information Prov-A of the TCMx whereas when the setting information Prov-B represents “DIS”, “66” is entirely inserted into the ODUk-OCI. A state in which “66” is entirely inserted into the ODUk-OCI is illustrated in FIG. 21B. Here, “01100110” which occupies a payload of data is a binary number of “66”.

As illustrated in FIG. 22, information representing a determination as to whether cross-connect is performed (the determination is negative in this case) is transmitted from the ALM code transmission unit 50 on the A side to the ALM code reception unit 51 on the B side and the information is used for generation of the ODUk-OCI in the ODU_EG OH/ODUT_EG OH [TX(INS)].

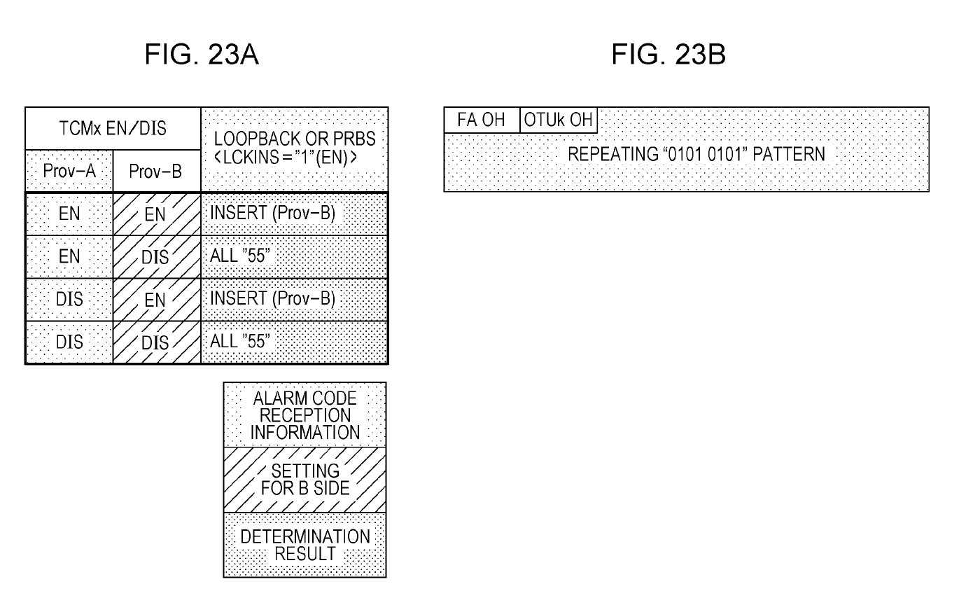

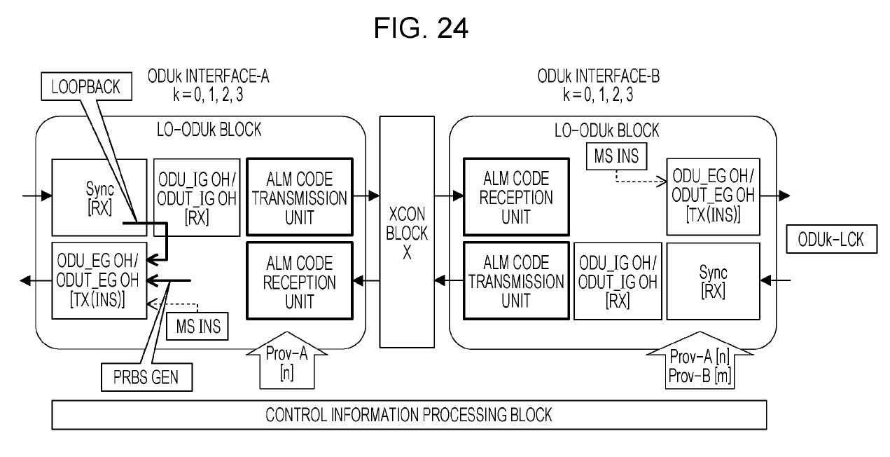

FIGS. 23A, 23B, and 24 are diagrams illustrating a determination and a process performed by the control information processing block 52 when signal replacement is performed to obtain ODUk-LCK (LoCK). As illustrated in FIG. 23A, LCK INS (or loopback or PRBS control information) supplied from the A side is 1, a process is performed. In the table of FIG. 23A, the TCM has six setting values, and a result of a logical sum of the six setting values of the TCM is represented by “EN (Enable)/DIS (Disable)” of the TCMx. Therefore, if at least one of the six TCMs corresponds to “EN”, the TCMx is determined to be “EN”. For example, when the setting information Prov-B of the TCMx represents “EN”, the setting information Prov-B is inserted into the ODUk-LCK irrespective of the setting information of the Prov-A of the TCMx whereas when the setting information Prov-B of the TCMx represents “DIS”, “55” is entirely inserted into the ODUk-LCKs. FIG. 23B illustrates a state of data in which the ODUk-LCK is occupied by “55”. Here, “01010101” illustrated in FIG. 23B is a binary number of “55”.

As illustrated in FIG. 24, when the LCK INS represents 1, a signal input to the A (B) side is looped back in the LO-ODUk block on the A (B) side. In this case, the LCK INS is transmitted from the ALM code transmission unit 50 on the A (B) side to the ALM code reception unit 51 on the B (A) side, and the LCK INS is used for generation of the ODUk-LCK in the ODU_EG OH/ODUT_EG OH [TX(INS)].

As described above, according to, the ALM code transmission unit 50, the ALM code reception unit 51, and the control information processing block 52 a problem in which an alarm detected on the ingress side is transmitted as a trigger to the ingress side and signal replacement to be performed in accordance with a control state is not performed since the TX blocks on the ingress side are removed and a problem in which the alarm is not detected on the egress side since the RX blocks on the egress side are removed is solved.

As described above, the following operations are performed: the ALM code information is defined in the OH of a main frame (ODU frame) and the alarm code information is processed and transmitted by the ALM code transmission unit 50; the control information processing block 52 used to collectively transmit the control processing information and the cross-connect connection information on the ingress side for control of the egress side is provided; an OH operation determination is performed in accordance with the alarm code information of the ALM code transmission unit 50, the control process information of the control information processing block 52, and the control process information on the egress side by the ALM code reception unit 51.

By this, an alarm state, a setting state, and a control state on the ingress side is recognized on the egress side, and in an apparatus having a cross-connect function, a connection state of cross-connect is recognized.

Specifically, while the signal replacement function is provided in accordance with the ITU-T G.709 standard and the ITU-T G.798 standard in the OTN-MXP and the OTN-SW apparatus, the functional blocks which are overlapping functions on the ingress side and the egress side (the TX blocks on the ingress side and the RX blocks on the egress side) are removed. Accordingly, problems such as increase of capacity of components, increase of the number of components, increase of power consumption, and increase of price caused by increase of a circuit size is solved. Specifically, in development of the OTM-MXT and the OTN-SW apparatuses of 40 G or 100 G, a circuit size is considerably reduced (reduction of approximately 50%).

This embodiment does not depend on presence or absence of implement of an ODU XC function included in the OTN network, does not depend on presence or absence of a function of multiplexing and demultiplexing an LO-ODU frame so that an OH-ODU frame is obtained, and is applicable to apparatuses which process an OTN frame.

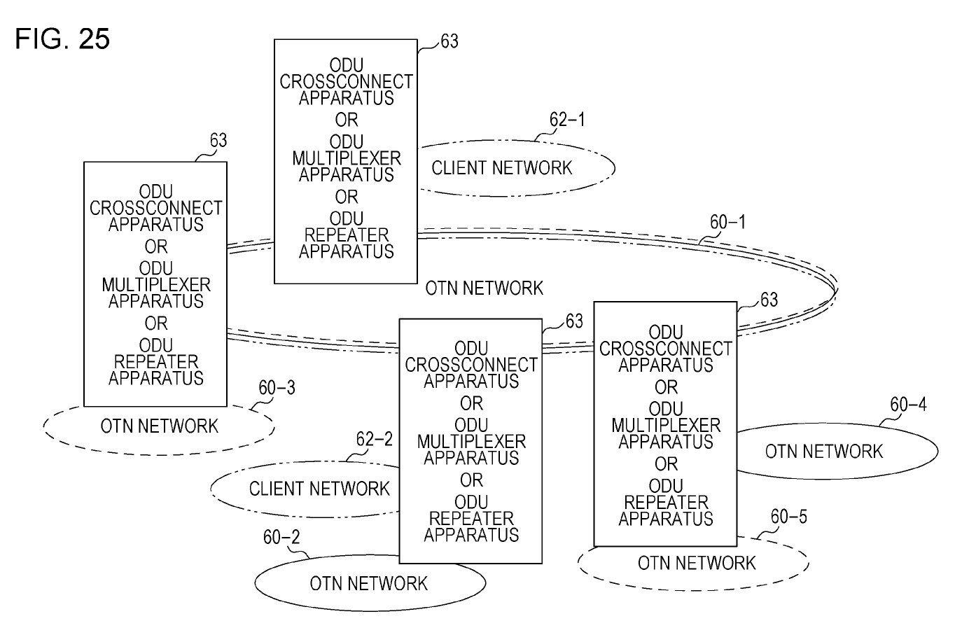

FIG. 25 is a diagram illustrating an image of the OTN network to which this embodiment is to be applied. In a configuration illustrated in FIG. 25, an OTN network 60-1 has a ring shape, and nodes 63 are connected to the OTN network 60-1. Examples of the nodes 63 include an ODU cross-connect (XC) apparatus, an ODU multiplexer apparatus, and an ODU repeater. To the nodes 63, other OTN networks 60-2 to 60-5 are connected, and client networks 62-1 and 62-2 are connected. The optical network apparatus of this embodiment corresponds to the nodes 63 and may be an ODU cross-connect (XC) apparatus, an ODU multiplexer apparatus, or an ODU repeater.

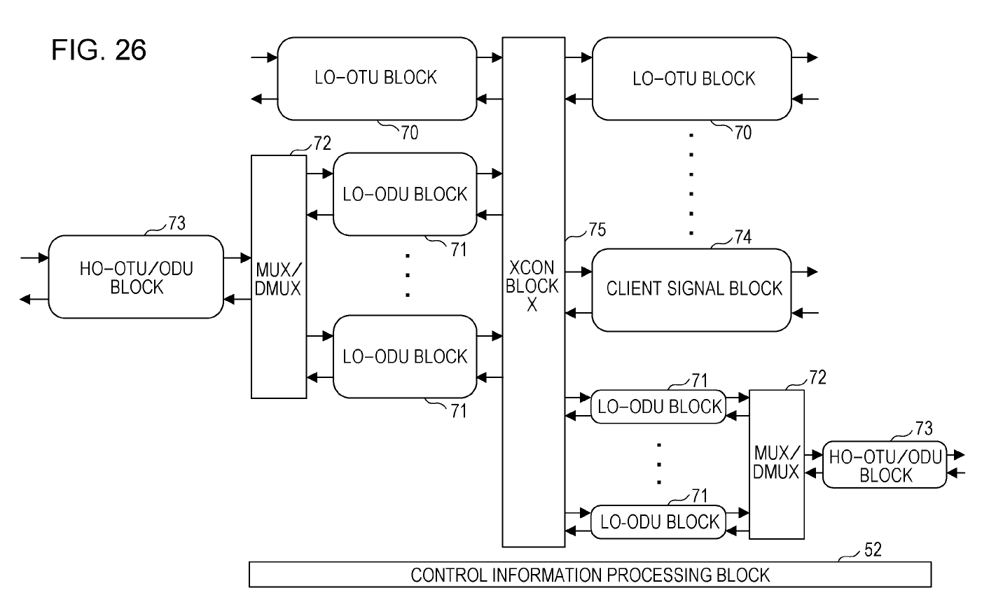

FIG. 26 is a diagram illustrating a configuration of an ODU cross-connect apparatus. As illustrated in FIG. 26, the ODU cross-connect apparatus includes an XCON block X (XC processor) 75 as a center, an HO-OTU/ODU block 73, an MUX/DEMUX block 72, LO-OTU blocks 70, LO-ODU blocks 71, and client signal blocks 74. This embodiment is applicable to the LO-OTU blocks 70, the LO-ODU blocks 71, the client signal block 74, and the HO-OTU/ODU block 73 which are connected to the XCON block 75.

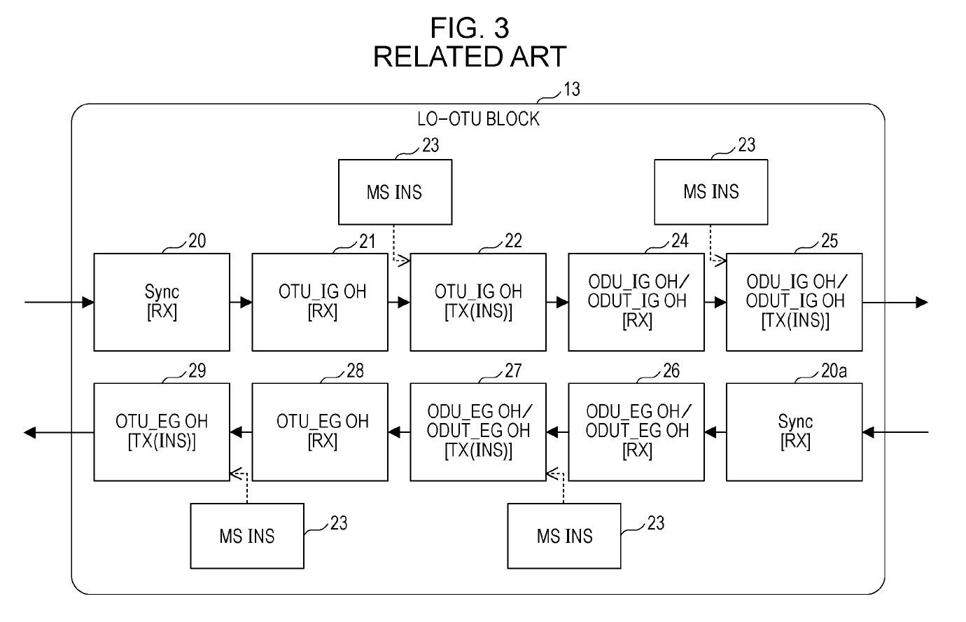

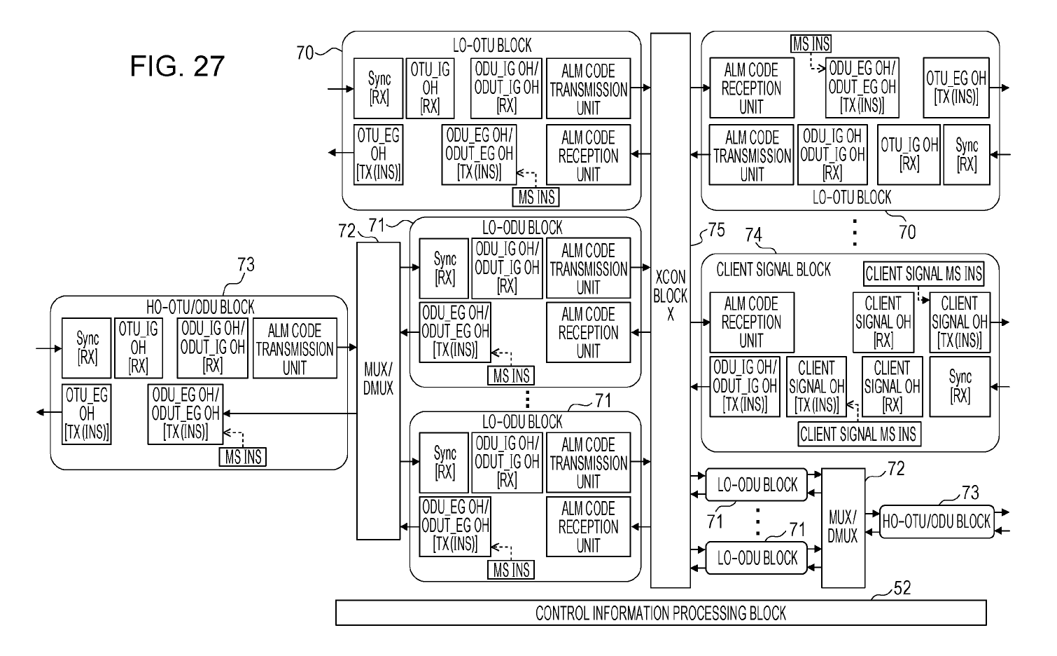

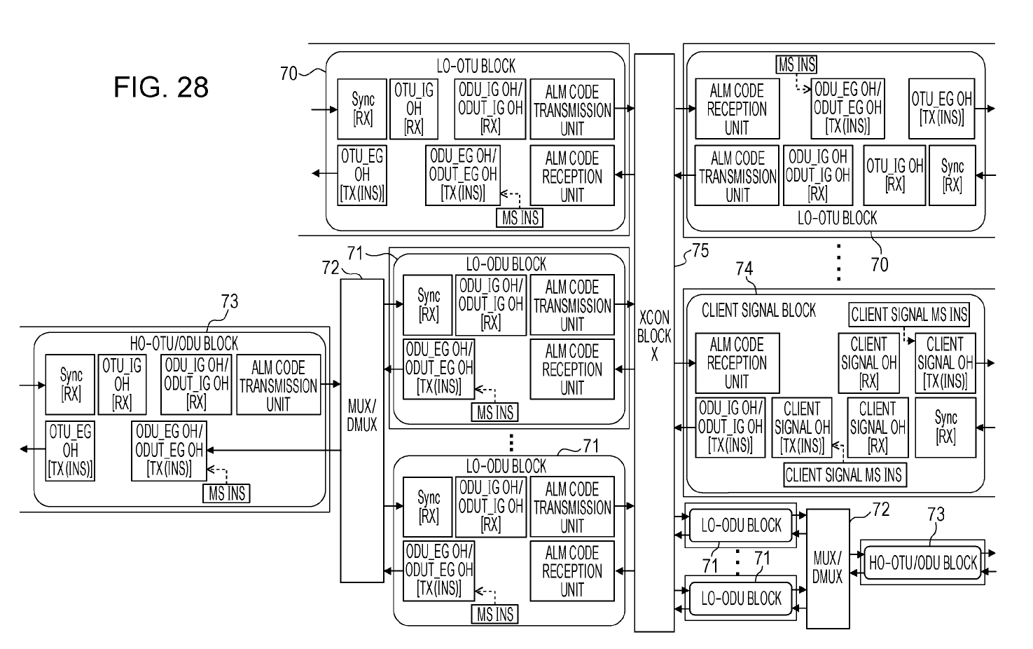

FIGS. 27 and 28 are diagrams illustrating block configurations of the ODU cross-connect apparatus to which the embodiment is applied. When compared with the LO-OTU block 13 illustrated in FIG. 3, each of the LO-OTU blocks 70 illustrated in FIG. 27 additionally includes an ALM code transmission unit and an ALM code reception unit, but blocks corresponding to the OTU_IG OH [TX(INS)], the ODU_EG OH/ODUT_EG OH [RX], the OTU_EG OH [RX], the ODU_IG OH/ODUT_IG OH [TX(INS)], the Sync [RX], and the three MS INSs are removed.

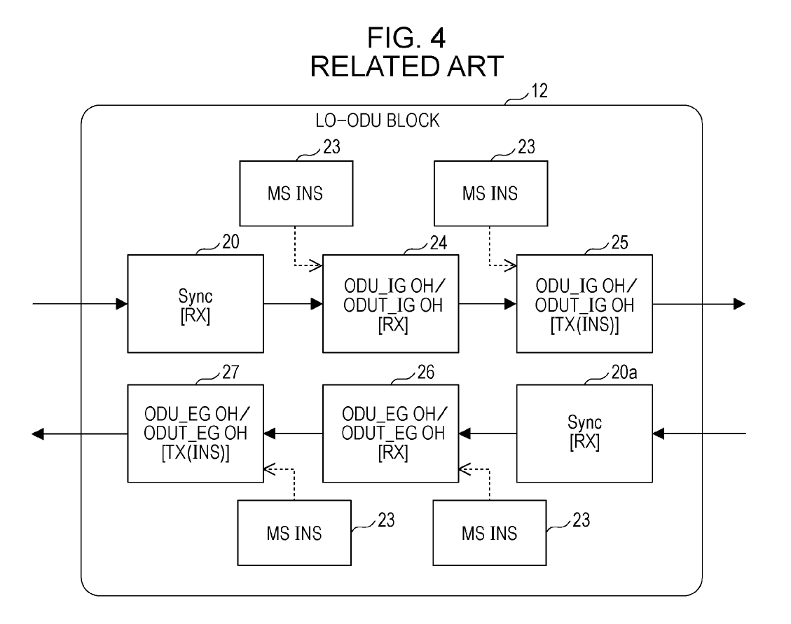

Furthermore, when compared with the LO-ODU block 12 illustrated in FIG. 4, each of the LO-ODU blocks 71 additionally includes an ALM code transmission unit and an ALM code reception unit, but blocks corresponding to the ODU_IG OH/ODUT_IG OH [TX(INS)], the ODU_EG OH/ODUT_EG OH [RX], the Sync [RX], and the three MS INSs are removed.

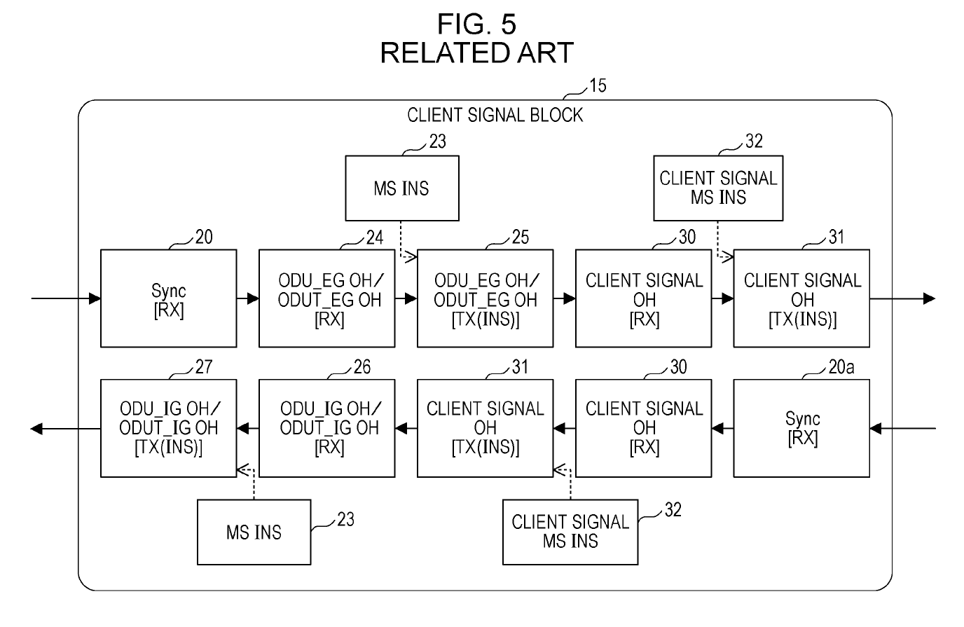

Moreover, when compared with the client signal block 15 illustrated in FIG. 5, each of the client signal blocks 74 additionally includes an ALM code reception unit, but blocks corresponding to the Sync [RX], the ODU_EG OH/ODUT_EG OH [RX], the ODU_EG OH/ODUT_EG OH [TX(INS)], the ODU_IG OH/ODUT_IG OH [RX] and the two MS INSs are removed. Note that each of the client signal blocks 74 receives a signal of the SONET and a signal of the Ethernet (registered trademark) from a client network or the like and supplies the signal to the XC processor 75. In this case, since an alarm signal of the SONET or an alarm signal of the Ethernet (registered trademark) is not supplied to the OTN, each of the client signal blocks 74 does not include an ALM code transmission unit.

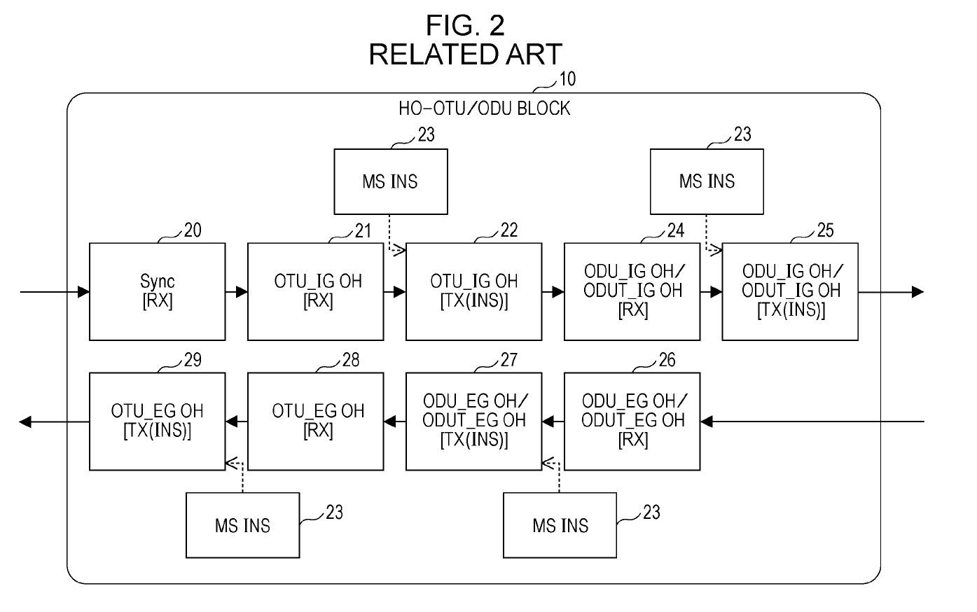

Furthermore, when compared with the HO-OTU/ODU block 10 illustrated in FIG. 2, the HO-OTU/ODU block 73 additionally includes an ALM code transmission unit, but blocks corresponding to the OTU_IG OH [TX(INS)], the ODU_IG OH/ODUT_IG OH [TX(INS)], the ODU_EG OH/ODUT_EG OH [RX], the OTU_EG OH [RX], and the three MS INSs are removed. Note that, since alarm information of a higher order signal is included in a lower order signal at a time of transmission, the HO-OTU/ODU block 73 includes the ALM code transmission unit. However, since alarm information of a lower order signal is not included in a higher order signal at a time of transmission, the HO-OTU/ODU block 73 does not include an ALM code reception unit. Note that a plurality of control information processing block 52 may be provided.

FIG. 28 is a diagram illustrating a configuration when the blocks of the configuration of FIG. 27 are configured as individual apparatuses. In FIG. 28, components the same as those illustrated in FIG. 27 are denoted by reference numerals the same as those illustrated in FIG. 27, and detailed descriptions thereof are omitted.

In FIG. 28, the blocks are enclosed by respective rectangular lines. This represents a state in which the blocks are mounted on different semiconductor chips or different shelves. In FIG. 28, the blocks mounted on the different semiconductor chips or the different shelves are connected to one another through wiring so that an entire optical network apparatus is configured. Functions of the blocks mounted on the different semiconductor chips or the different shelves may be realized by hardware or firmware executed by a processor. An ODU repeater apparatus may be configured by combining the blocks illustrated in FIG. 27 or FIG. 28.

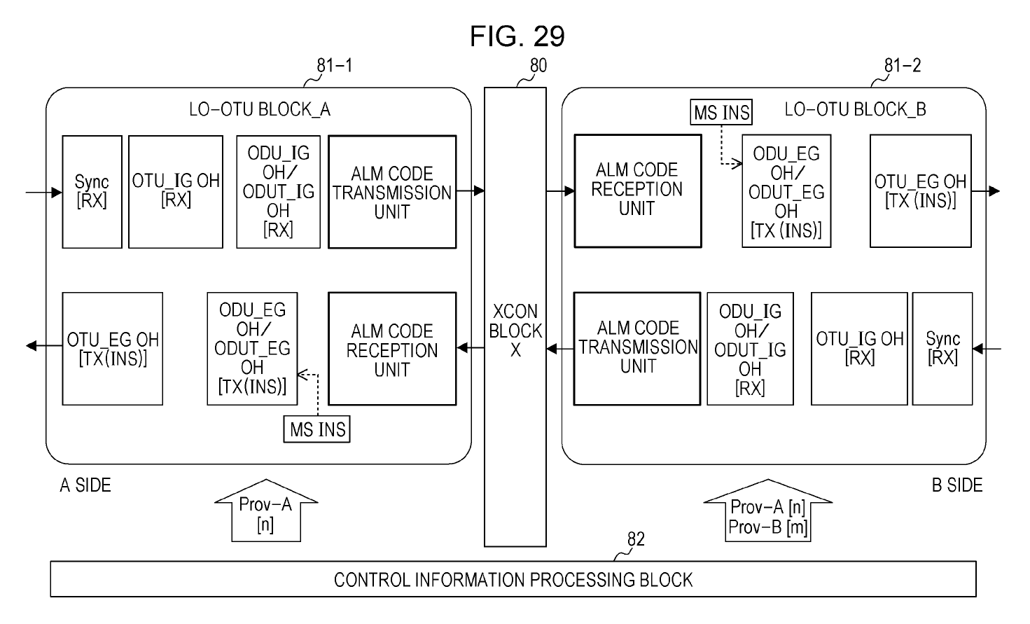

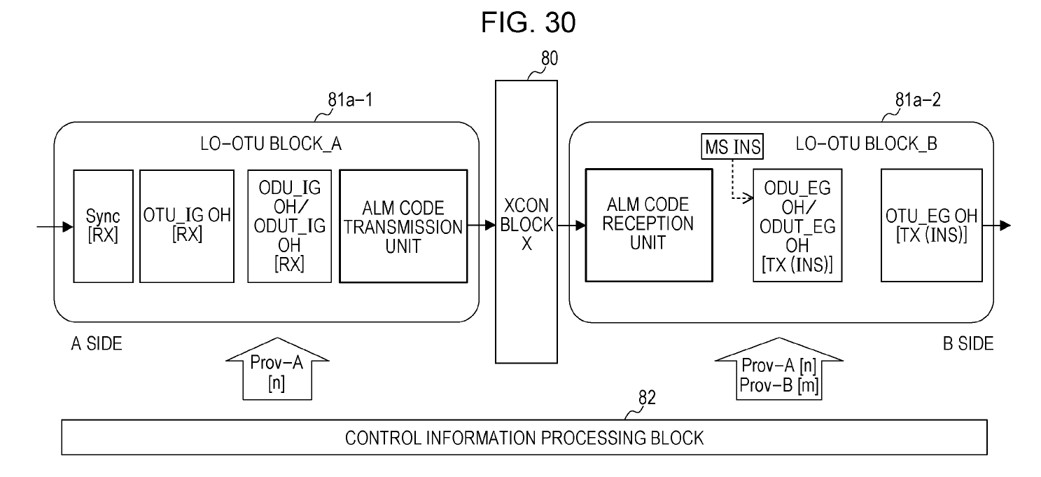

FIGS. 29 and 30 are diagrams illustrating a block configuration of an ODU repeater apparatus. FIG. 29 illustrates a bidirectional repeater apparatus and FIG. 30 illustrates an one-way repeater apparatus. In FIG. 29, an XC processor 80 is sandwiched by an LO-OTU block_A 81-1 and an LO-OTU block_B 81-2, and a control information processing block 82 which controls transmission of alarm information is provided. In each of the LO-OTU block_A 81-1 and the LO-OTU block_B 81-2, blocks corresponding to the OTU_IG OH [TX(INS)], the ODU_EG OH/ODUT_EG OH [RX], the OTU_EG OH [RX], the OTU_IG OH/ODUT_IG OH [TX(INS)], the Sync [RX] and the three MS INSs are removed, and instead, an ALM code transmission unit and an ALM code reception unit are added. Since the configuration in FIG. 29 allows bidirectional transmission of signals, a transmission of alarm information from the A side to the B side and a transmission of alarm information from the B side to A side are symmetric.

In the one-way repeater apparatus of FIG. 30, a signal transmission from the A side to the B side is illustrated. In an LO-OTU block A 81a-1, the OTU_IG OH [RX], the OTU_IG OH/ODUT_IG OH [TX(INS)], and the two MS INSs are removed, and an ALM code transmission unit is added. On the other hand, in an LO-OTU block B 81a-2, the Sync [RX], the OTU_EG OH/ODUT_EG OH [RX], the OTU_EG OH [RX], and the MS INS are removed and an ALM code reception unit is added. An ODU muxponder apparatus may be configured by combining the blocks illustrated in FIG. 27.

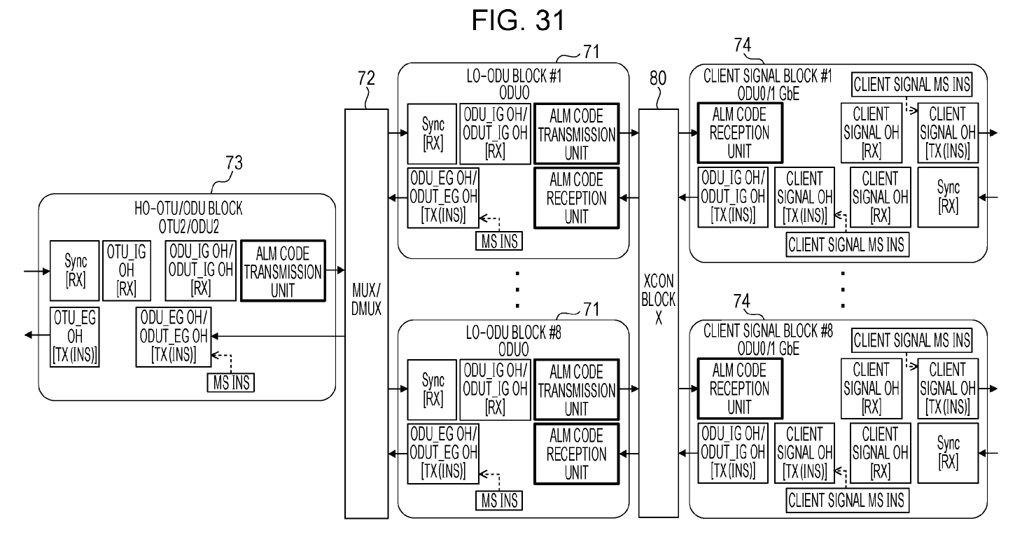

FIG. 31 is a diagram illustrating a block configuration of an ODU muxponder apparatus. In FIG. 31, the ODU muxponder includes a single HO-OTU/ODU block 73 as an OTU2/ODU2 processor, eight LO-ODU blocks 71 as ODU0 processors, and eight client signal blocks 74 as ODU0/1 GbE processor. However, the HO-OTU/ODU block 73 may function as an OTU4/ODU4 processor, an OTU3/ODU3 processor, or an OTU1/ODU1 processor.

Furthermore, the LO-ODU blocks 71 may function as ODU2 processors or ODU1 processors, and an arbitrary number of LO-ODU blocks 71 may be provided. A standard of the client signal blocks 74 is not limited to GbE and any standard may be employed as long as mapping on the OTN frame (ODU2/ODU2/ODUflex) is enabled, and an arbitrary number of client signal blocks 74 may be provided. Here, it is not necessarily the case that the muxponder changes a setting of the XC processor in operation, and an apparatus or a system having a fixed switching function for convenience of operation may be used as the muxponder.

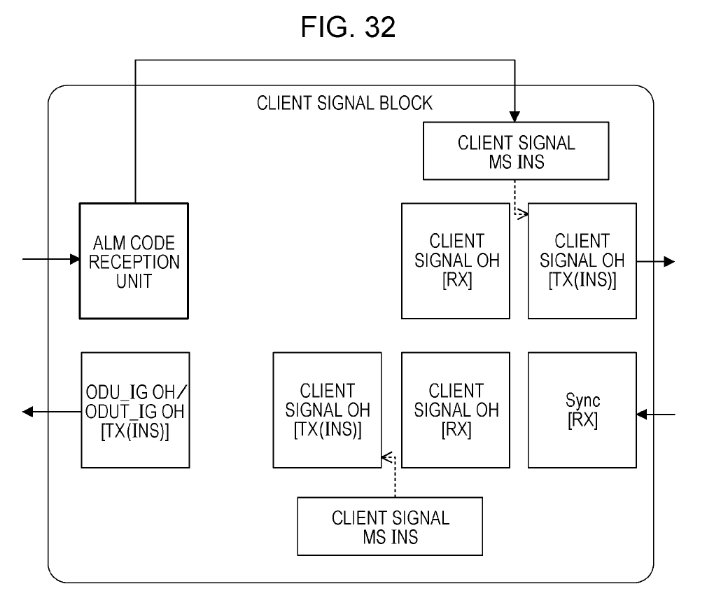

FIG. 32 is a diagram illustrating a signal replacement process performed in accordance with a type of a client signal in a client signal block process on an egress side. For example, a client signal MS INS performs an insertion of an LFS (/C1/C2/pattern) or /V/code of 1 GbE, an insertion of an LF of 10 GbE, an insertion of an AIS-L of the SONET, and the like which are maintenance signals on an OH of a client signal so as to generate a client signal having the OH in a client signal OH [TX(INS)]. For example, when the client signal conforms to the SONET, the MS INS performs the insertion of an AIS (Alarm Indication Signal).

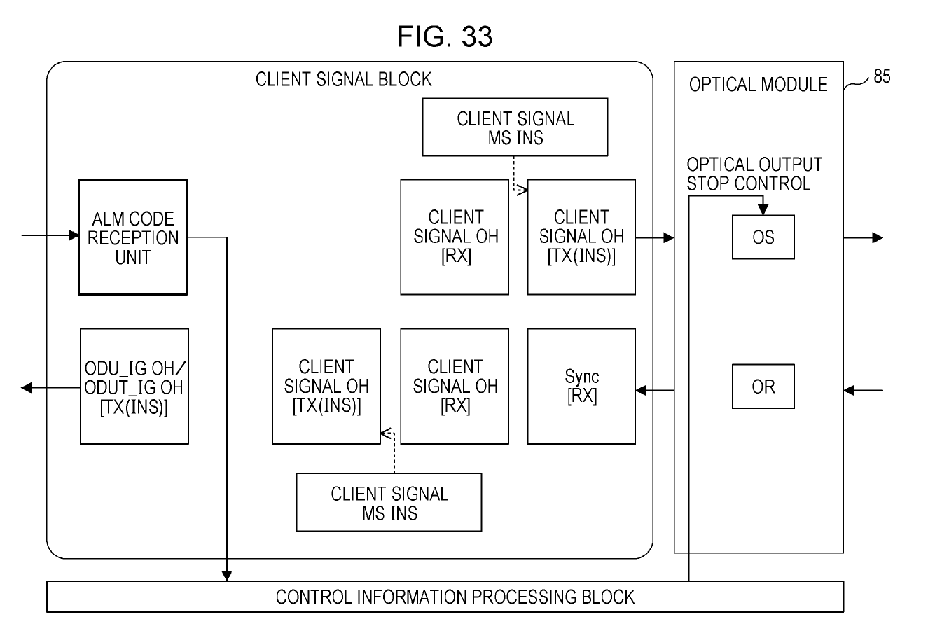

FIG. 33 is a diagram illustrating a process of stopping an output of an optical module performed irrespective of a type of a client signal in a client signal block process on the egress side. When the control information processing block detects an occurrence of a failure from alarm information received by the ALM code reception unit of the client signal block, a failed signal may be interrupted. In this case, the control information processing block performs optical output stop control on an OS of an optical transmission unit of an optical module 85 so as to stop oscillation of an optical signal. This function may be implemented not only on the client signal block but also on the LO-OTU block on the egress side as a similar process.

Note that, as for the alarm code information, in an apparatus which performs an FTFL process but does not perform a TCM process, only a transmission of an alarm level and information similar to FW FTFL INS are requested, and the LCK INS may be set only on the egress side as long as the control information processing block recognizes the LCK INS.

Furthermore, as for the alarm code information, in an apparatus which does not perform an FTFL process but performs a TCM process, only a transmission of information on an alarm level is requested, and the TCM1 EN, the TCM2 EN, the TCM3 EN, the TCM4 EN, the TCM5 EN, the TCM6 EN, and the LCK INS may be set only on the egress side as long as the control information processing block recognizes the TCM1 EN, the TCM2 EN, the TCM3 EN, the TCM4 EN, the TCM5 EN, the TCM6 EN, and the LCK INS.

Although the alarm level of the alarm code information is represented by two bits (alarm level=0/1/2/3) in the foregoing embodiment, the alarm level is not limited to two bits and may be 3 bits or more. Furthermore, although a value equal to or larger than 2 may set in a threshold value of the insertion of the maintenance signal in the foregoing description, when the alarm level is expanded to 2 bits or more, the setting of the threshold value is determined by a designer of the system in accordance with the expansion.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical network apparatus included in an optical network in which alarm information including a type and a position of a generated failure is transferred, the optical network apparatus comprising:
a reception unit configured to detect alarm information from a received signal, generate alarm code information representing content of an alarm from the alarm information, and transmit a signal including the alarm code information;
a transfer unit configured to switch and transfer the signal transmitted from the reception unit; and
a transmission unit configured to replace the alarm information included in the signal transferred from the transfer unit, based on the alarm code information, setting information of the transmission unit and setting information of the reception unit, and to transmit the signal including the replaced alarm information.

2. The optical network apparatus according to claim 1, wherein the optical network is an optical transport network (OTN).

3. The optical network apparatus according to claim 2, wherein the alarm information includes a fault type and fault location reporting channel (FTFL).

4. The optical network apparatus according to claim 1, wherein the transfer unit includes a cross-connect processor performing a switching process on the signal.

5. The optical network apparatus according to claim 1, wherein the alarm code information is transmitted using a reserved region of an overhead signal of the received signal.

6. The optical network apparatus according to claim 1, wherein the alarm code information is transmitted using a header which is uniquely included in the received signal.

7. The optical network apparatus according to claim 1, wherein the alarm code information is transmitted through a path other than that used to transmit the received signal.

8. The optical network apparatus according to claim 1, wherein the optical network apparatus is employed in a cross-connect apparatus.

9. The optical network apparatus according to claim 1, wherein the optical network apparatus is employed in a muxponder apparatus.

10. The optical network apparatus according to claim 1, wherein the optical network apparatus is employed in a repeater apparatus.

11. The optical network apparatus according to claim 1, wherein the optical network apparatus is employed in a processing apparatus including control of stop of optical output of an optical module.

12. The optical network apparatus according to claim 1, wherein the reception unit and the transmission unit are mounted on different shelves.

13. The optical network apparatus according to claim 1, wherein the reception unit and the transmission unit are mounted on different semiconductor chips.

14. The optical network apparatus according to claim 1, wherein the reception unit and the transmission unit are mounted on different semiconductor chips and functions of the reception unit and the transmission unit are realized by firmware executed by each processor or an integrated processor of the reception unit and the transmission unit.
